(19) United States
(12) Patent Application Publication
(10) Pub. No.: US 2020/0412228 A1
(43) Pub. Date: Dec. 31, 2020

(54) VIBRATION MOTOR

(71) Applicant: AAC Technologies Pte. Ltd., Singapore city (SG)

(72) Inventors: Lubin Mao, Shenzhen (CN); Zijie Zhang, Shenzhen (CN)

(21) Appl. No.: 16/994,691

(22) Filed: Aug. 17, 2020

Related U.S. Application Data
(63) Continuation of application No. PCT/CN2019/093984, filed on Jun. 29, 2019.

(51) Int. Cl. H02K 33/18

(52) U.S. Cl. CPC H02K 33/18; B06B 1/045

(57) ABSTRACT

A vibration motor includes a housing, a vibrator and a stator received in the housing. The vibrator includes a magnetic circuit unit for vibration. The stator includes a coil configured to drive the magnetic circuit unit to vibrate. The coil has a winding plane perpendicular to a vibration direction of the vibrator. The magnetic circuit unit includes first and second magnet groups provided on opposites sides of the coil. The first magnet group and the second magnet group each include a plurality of magnets arranged along the vibration direction and magnetized in a direction perpendicular to the vibration direction, such that two adjacent magnets in the vibration direction have opposite magnetization directions, and the magnets oppositely arranged in the first and second magnet groups have opposite magnetization directions. The vibrator according to the present disclosure has a large driving force and a quick response during vibration.

### FIELD OF THE INVENTION

The present disclosure relates to the field of vibration motors, and in particular to a vibration motor.

### BACKGROUND

Vibration motors are devices for converting electrical energy into mechanical energy by use of the principle of electromagnetic force generation. A vibration motor is usually installed in a portable mobile device to generate haptic feedback, such as haptic feedback in mobile phones or game machines.

In the related art, the vibration motor usually only provides a driving force by the Lorentz force generated by interaction of a coil and a magnetic field of a magnet to drive the vibrator to vibrate reciprocatingly. However, the driving force provided by the vibration motor as mentioned above is small, such that the response time of the vibration is long.

Therefore, it is necessary to provide a novel vibration motor to solve the above problems.

### SUMMARY

The purpose of the present disclosure is to provide a vibration motor which can provide a large driving force and a quick response during vibration.

The present disclosure provides a vibration motor which comprises a housing with a receiving space, a vibrator received in the receiving space, and a stator received in the receiving space. The vibrator comprises a magnetic circuit unit for vibration. The stator comprises a coil configured to drive the magnetic circuit unit to vibrate. The coil has a winding plane perpendicular to a vibration direction of the vibrator. The magnetic circuit unit comprises a first magnet group disposed at one side of the coil and a second magnet group disposed at the other side of the coil. The first magnet group and the second magnet group are symmetrically arranged and each comprises a plurality of magnets arranged along the vibration direction of the vibrator and magnetized in a direction perpendicular to the vibration direction of the vibrator. Magnetization directions of two adjacent magnets in the vibration direction of the vibrator are reverse to each other, and magnetization directions of the magnets oppositely arranged in the first magnet group and second magnet group are reverse to each other.

In some embodiments, the magnetic circuit unit further comprises a magnetically conductive frame fixedly connected with the magnets, the magnetically conductive frame includes a first magnetically conductive plate attached to the first magnet group and a second magnetically conductive plate attached to the second magnet group, the first magnetically conductive plate is disposed on a side of the first magnet group away from the second magnet group, and the second magnetically conductive plate is disposed on a side of the second magnet group away from the first magnet group.

In some embodiments, the vibrator further comprises a weight in which the magnetic circuit unit is mounted, the weight is suspended in the receiving space, the weight comprises two long side walls spaced apart and parallel to each other and two short side walls arranged at two ends of the long side walls and connecting the two long side walls, the long side walls and the short side walls are connected end to end to form a receiving cavity, and the magnetically conductive frame and the coil are received in the receiving cavity.

In some embodiments, the first magnetically conductive plate is sandwiched between the first magnet group and one of the long side walls, and the second magnetically conductive plate is sandwiched between the second magnet group and the other of the long side walls.

In some embodiments, the short side walls are recessed at opposite ends in a height direction of the housing to form notches, and the vibration motor further comprises limiting blocks corresponding to the notches, the limiting blocks are fixedly connected with the housing, and the notches cooperate with the limiting blocks to limit the displacement amount of the vibrator in the vibration direction.

In some embodiments, the first magnet group comprises a first magnet, a second magnet and a third magnet arranged sequentially in the vibration direction, wherein the magnetization direction of the first magnet is opposite to that of the second magnet, and the magnetization direction of the first magnet is the same as that of the third magnet; the second magnet group comprises a fourth magnet, a fifth magnet and a sixth magnet arranged sequentially in the vibration direction, wherein the magnetization direction of the fourth magnet is opposite to that of the fifth magnet, and the magnetization direction of the four magnets is the same as that of the sixth magnet.

In some embodiments, the first magnet and the fourth magnet are directly opposite to each other and have opposite magnetization directions; the second magnet and the fifth magnetic magnet are directly opposite to each other and have opposite magnetization directions; the third magnet and the sixth magnet are directly opposite to each other and have opposite magnetization directions.

In some embodiments, the magnetic circuit unit further comprises a third magnet group fixed to the short side walls, the third magnet group comprises a seventh magnet and an eighth magnet arranged oppositely, the seventh magnet and the eighth magnet are magnetized in a direction parallel to the vibration direction of the vibrator such that the seventh magnet and the eighth magnet have opposite magnetization directions.

In some embodiments, the vibration motor further comprises an elastic member which is fixed to the weight at one end and is fixed to the housing at the other end, thereby suspending the vibrator in the receiving space.

In some embodiments, the vibration motor further comprises two elastic members, the weight comprises two ends in the vibration direction, one of the elastic members is fixed to one end of the weight and the housing, and the other one of the elastic members is fixed to the other end of the weight and the housing, thereby suspending the vibrator in the receiving space.

In some embodiments, the stator further comprises a soft magnet fixedly connected to the coil and two brackets fixed at opposite ends of the soft magnet respectively, the coil is fixedly connected to the housing, and the coil is sleeved on the soft magnet.

In some embodiments, at least one of the two brackets is provided separately from the soft magnet.

Compared with the related art, the magnetic circuit unit of the vibration motor according to the present disclosure includes a soft magnet and a coil sleeved on the soft magnet, and a magnetically conductive plate and permanent magnets are provided around the peripheral of the coil such that the Lorentz force generated by the magnets and the energized coil and the interaction force acting between the magnetized soft magnet and the permanent magnets are superimposed and cooperatively drive the weight to vibrate, thereby increasing the driving force for driving the weight and obtaining a quick response.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 is a schematic perspective view of a vibration motor according to an exemplary embodiment of the present disclosure;

FIG. 2 is an exploded schematic view of the vibration motor shown in FIG. 1;

FIG. 3 is a cross-sectional view of the vibration motor shown in FIG. 1, taken along line III-III;

FIG. 4 is a cross-sectional view of the vibration motor shown in FIG. 1, taken along line IV-IV;

FIG. 5(a) is a schematic diagram of magnetizing directions of the magnetic circuit unit and the stator of the vibration motor shown in FIG. 2, the coil of the stator being fed with a current in one direction;

FIG. 5(b) is a schematic diagram of magnetizing directions of the magnetic circuit unit and the stator of the vibration motor shown in FIG. 2, the coil of the stator being fed with a current in an reverse direction;

FIG. 6 is similar to FIG. 4 except that the magnetic circuit unit further comprises a third magnet group; and

FIG. 7 is a schematic diagram of polarities of the magnetic circuit unit and the stator shown in FIG. 6.

### DESCRIPTION OF THE EMBODIMENTS

The technical solutions in embodiments of the present disclosure will be clearly and completely described with reference to the accompanying drawings of the present disclosure. It is evident that the elements described are only some rather than all embodiments of the present disclosure. Based on the embodiments of the present disclosure, all other embodiments obtained by those skilled in the art without making any inventive effort fall into the protection scope of the present disclosure.

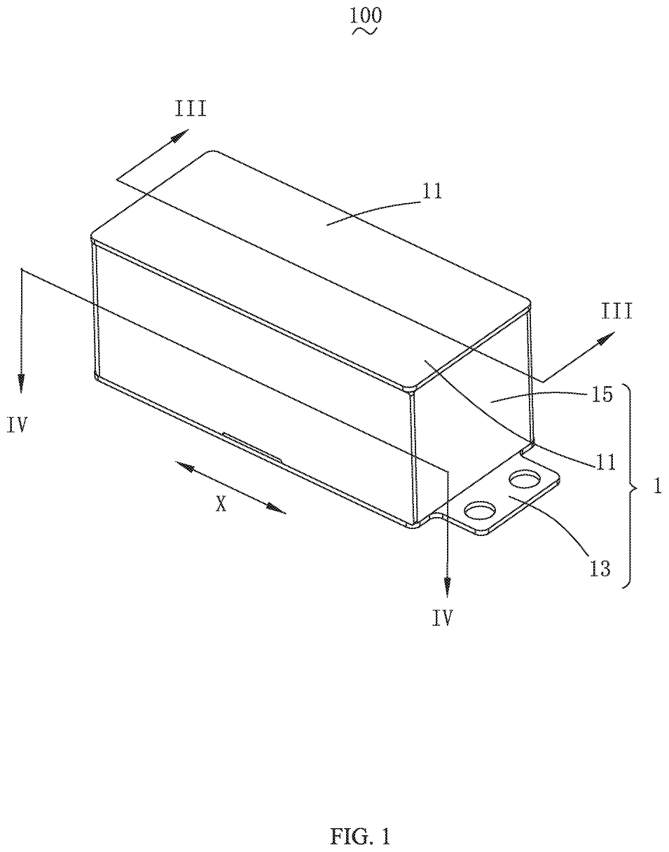

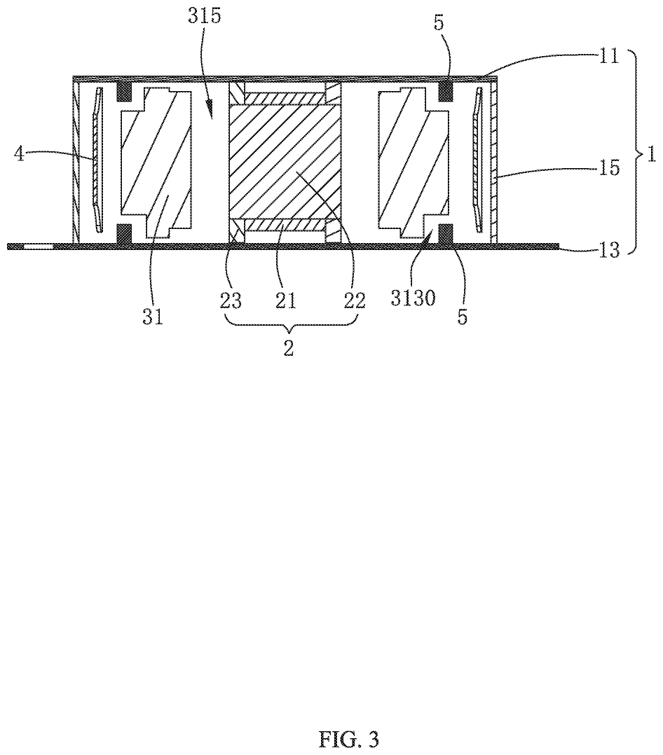

Referring to FIGS. 1-3, the present disclosure provides a vibration motor 100 including a housing 1, a stator 2, a vibrator 3, and an elastic member 4.

The housing 1 includes a top wall 11, a bottom wall 13 opposite to the top wall 11, and a side wall 15 connecting the top wall 11 and the bottom wall 13. The top wall 11, the bottom wall 13 and the side wall 15 cooperate to form a receiving space. The vibrator 3, the stator 2 and the elastic member 4 are received in the receiving space.

The side wall 15 includes two long sides 151 spaced apart and parallel to each other and two short sides 153 disposed at opposite ends of the long sides 151 and connecting the two long sides 151. The long sides 151 and the short sides 153 can be integrally formed in one piece or separately formed and then fixedly connected together.

In this embodiment, the top wall 11 and the side wall 15 are integrally formed and the bottom wall 13 directly covers on the side wall 15, which facilitates the assembly of the vibration motor 100. In other embodiments, the side wall 15 can also be integrally formed with the bottom wall 13.

The stator 2 is fixed to the housing 1. Specifically, the stator 2 is fixed to the bottom wall 13. The stator 2 includes a coil 21, a soft magnet 22 and a bracket 23.

The coil 21 has a winding plane perpendicular to a vibration direction of the vibrator 3. It should be noted that the winding plane of the coil 21 refers to a plane where a turn of the coil 21 is wound. The axis of the coil 21 is perpendicular to the winding plane.

The soft magnet 22 is made of iron-silicon alloy and has a cylindrical shape. The coil 21 is sleeved on an outer circumferential surface of the soft magnet 22. The coil 21 is fixedly connected to the soft magnet 22.

In this embodiment, the number of the brackets 23 is two. The two brackets 23 are fixedly arranged at opposite ends of the soft magnet 22 for fixing and supporting the soft magnet 22 and the coil 21. Preferably, the brackets 23 are made of magnetically conductive material. At least one of the brackets 23 is provided separately from the soft magnet 22, such that, during assembly, the coil 21 may be sleeved on the soft magnet 22 from one end thereof, which facilitates assembly and disassembly.

After the coil 21 is energized, the coil 21 and the soft magnet 22 cooperate to form an electromagnet. The energized coil 21 generates a magnetic field which magnetizes the soft magnet 22. The magnetic field generated by the magnetized soft magnet 22 and the magnetic field generated by the energized coil 21 are superimposed with each other, so that the intensity of the magnetic field generated by the electromagnet is greatly increased.

Understandably, it is possible to provide a plurality of stators 2 which are aligned with each other. The coils 21 of two adjacent stators 2 are fed with currents having opposite directions. The magnetic fields generated by the two stators 2 effect on the vibrator 3 at the same time, which can increase the driving force of the vibrator 3 and improve the vibration effect of the vibrator 3.

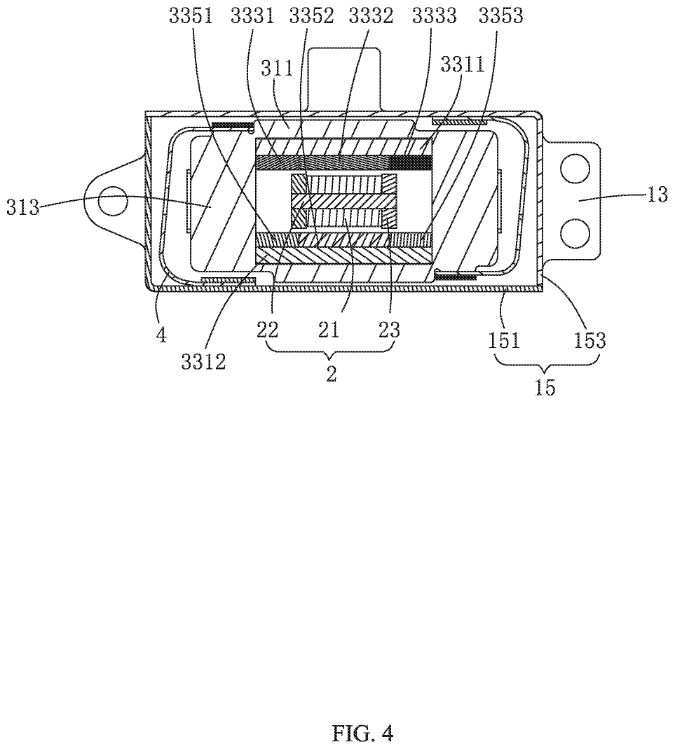

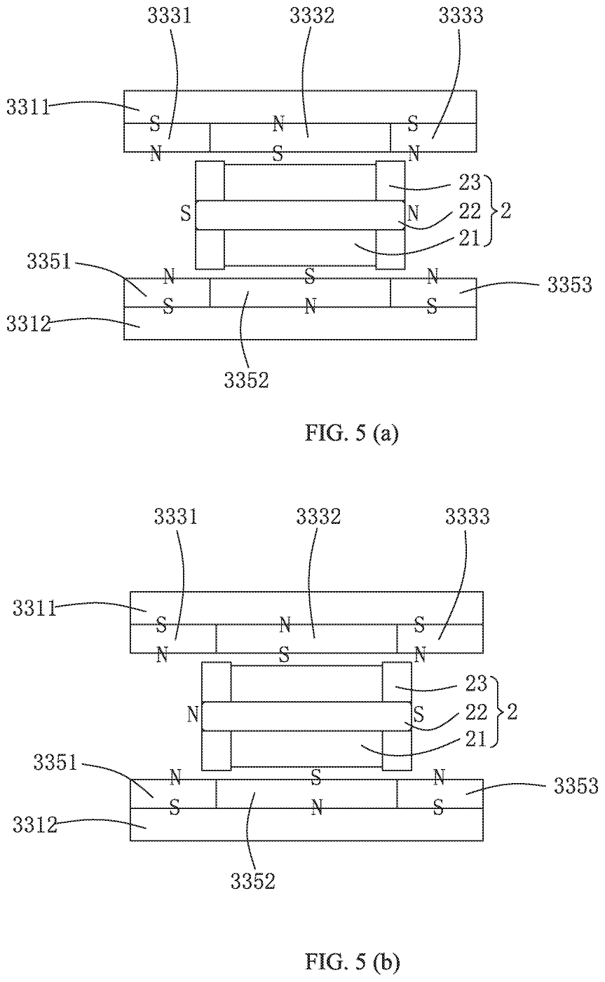

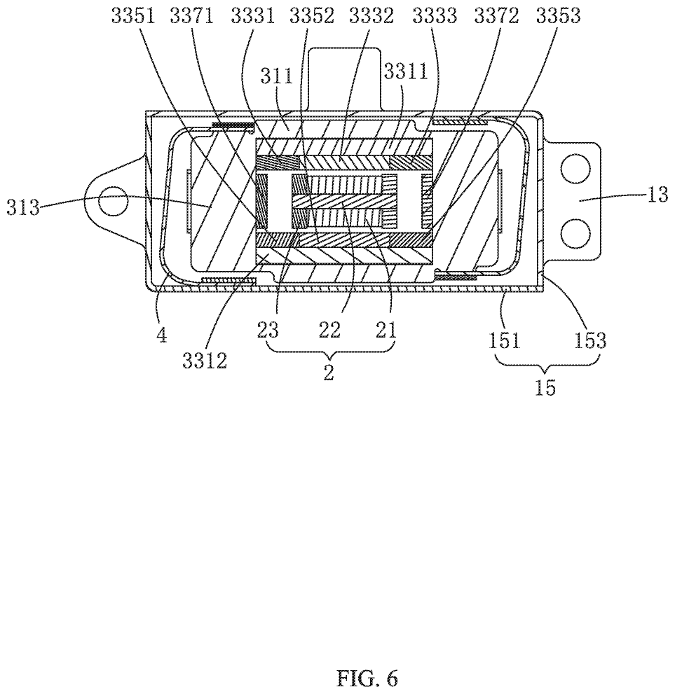

Referring to FIGS. 4 to 7, the vibrator 3 includes a weight 31 and a magnetic circuit unit 33 assembled with the weight 31. The weight 31 is suspended in the receiving space of the housing 1.

The weight 31 includes two long side walls 311 spaced apart and parallel to each other and two short side walls 313 disposed at opposite ends of the long side walls 311 and connected to the two long side walls 311. The long side walls 311 and the short side walls 313 are connected end to end to form a receiving cavity 315. It can be understood that an extending direction of the long side wall 311 is consistent with an extending direction of the long side 151 of the housing 1, and an extending direction of the short side wall 313 is consistent with an extending direction of the short side 153.

The short side walls 313 are recessed at each of two opposite ends in a height direction of the housing 1 to form notches 3130, and the two notches 3130 are symmetrically disposed at the ends of the short side wall 313. The notches 3130 communicate with the receiving space, and the notches 3130 are disposed on sides of the short side wall 313 away from the receiving cavity 315.

The vibration motor 100 further includes limit blocks 5 corresponding to the notches 3130, and the limit blocks 5 are fixedly connected to the housing 1. The notches 3130 cooperate with the limit blocks 5 to limit the displacement of the vibrator 3, thereby avoiding excessive vibration of the vibrator 3. In this embodiment, four limiting blocks 5 are provided, wherein the two limiting blocks 5 corresponding to the two notches 3130 arranged at the top end of the short side wall 313 are fixedly connected to the top wall 11, while the two limiting blocks 5 corresponding to the two notches 3130 arranged at the bottom end of the short side wall 31 are fixedly connected to the bottom wall 13.

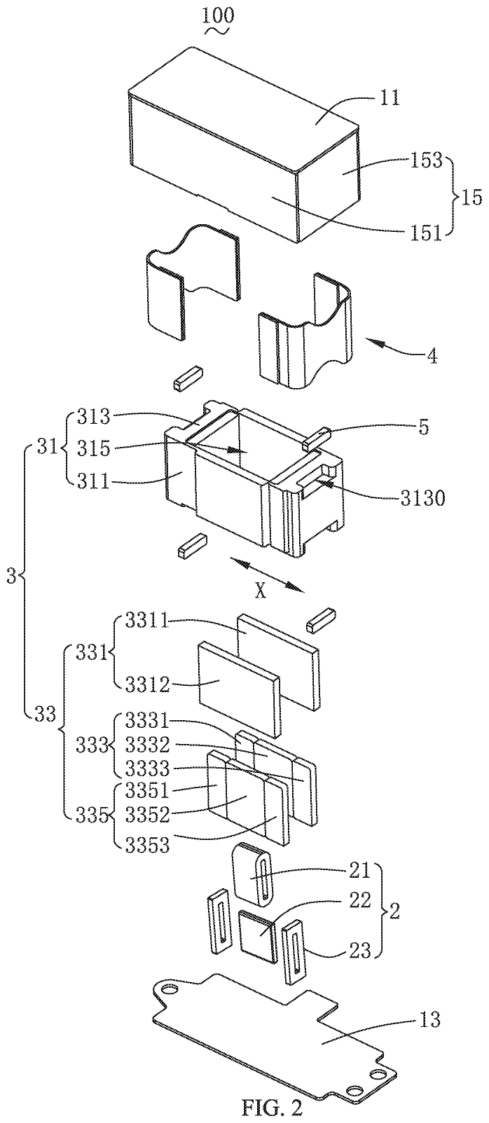

It can be understood that the vibration amount of the vibrator 3 is determined by the depth of the slot 3130 along an X-axis direction, wherein the X-axis direction is the vibration direction of the vibrator 3, that is, the direction indicated by the X-axis in FIG. 1 or FIG. 2.

The magnetic circuit unit 33 includes a magnetically conductive frame having two parallel and spaced magnetically conductive plates 331, a first magnet group 333 disposed on one side of the coil 21, and a second magnet group 335 disposed on the other side of the coil 21. The first magnet group 333 and the second magnet group 335 are respectively fixed to surfaces of the magnetically conductive plates 331 facing the stator 22. Preferably, the first magnet group 333 and the second magnet group 335 are arranged symmetrically.

The magnetically conductive plate 331 includes a first magnetically conductive plate 3311 and a second magnetically conductive plate 3312 disposed oppositely, the first magnetically conductive plate 3311 is sandwiched between the first magnet group 333 and one of the long side walls 311 of the weight 31, while the second magnetically conductive plate 3312 is sandwiched between the second magnet group 335 and the other of the long side walls 311.

The first magnet group 333 and the second magnet group 335 each includes a plurality of magnets arranged along the vibration direction of the vibrator 3, and two adjacent magnets in the same group have opposite magnetization directions. The magnets arranged at corresponding positions of the first magnet group 333 and second magnet group 335 are magnetized in opposite directions.

Specifically, in this embodiment, the first magnet group 333 includes a first magnet 3331, a second magnet 3332, and a third magnet 3333; the second magnet group 335 includes a fourth magnet 3351, a fifth magnet 3352 and a sixth magnet 3353, wherein the magnetization direction of the first magnet 3331 is opposite to that of the second magnet 3332, and the magnetization of the first magnet 3331 is the same as that of the third magnet 3333; the magnetization direction of the fourth magnet 3351 is opposite to that of the fifth magnet 3352, and the magnetization of the fourth magnet 3351 is the same as that of the sixth magnet 3353. Further, the first magnet 3331 and fourth magnet 3351 are symmetrically arranged and have opposite magnetization directions, the second magnet 3332 and the fifth magnet 3352 are symmetrically arranged and have opposite magnetization directions, and the third magnet 3333 and the sixth magnet 3353 are symmetrically arranged and have opposite magnetization directions. It should be noted that, in other embodiments, the first magnet group 333 may also include different numbers of magnets, which is not limited in the present disclosure. The number of magnets of the second magnet group 335 is the same as that of magnets of the first magnet group 333.

Specifically, in order to explain the content of the present disclosure more clearly, the magnetization directions of each of the magnets are defined as below:

A side of the first magnet 3331 near the first magnetically conductive plate 3311 is S pole while a side thereof away from the first magnetically conductive plate 3311 is N pole;

A side of the second magnet 3332 near the first magnetically conductive plate 3311 is N pole while a side thereof away from the first magnetically conductive plate 3311 is S pole;

A side of the third magnet 3333 near the first magnetically conductive plate 3311 is S pole while a side thereof away from the first magnetically conductive plate 3311 is N pole;

A side of the fourth magnet 3351 near the second magnetically conductive plate 3312 is S pole while a side thereof away from the second magnetically conductive plate 3312 is N pole;

A side of the fifth magnet 3352 near the second magnetically conductive plate 3312 is N pole while a side thereof away from the second magnetically conductive plate 3312 is S pole;

A side of the sixth magnet 3353 near the second magnetically conductive plate 3312 is S pole while a side thereof away from the second magnetically conductive plate 3312 is N pole;

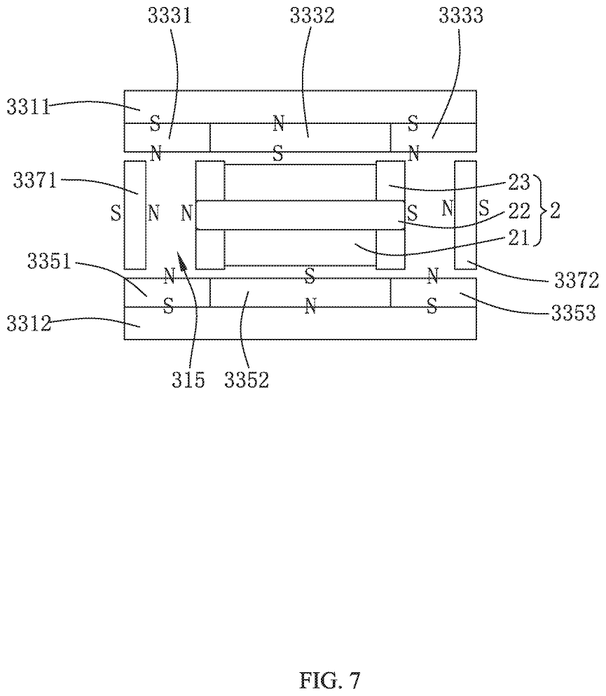

Referring to FIG. 7, in other embodiments, the magnetic circuit unit 33 further includes a third magnet group, which is fixed to the short side walls 313 and includes a seventh magnet 3371 and an eighth magnet 3372. The seventh magnet 3371 and the eighth magnet 3372 are arranged oppositely, and each is fixedly connected to one of the short side walls 313. The seventh magnet 3371 and the eighth magnet 3372 are magnetized in a direction parallel to the vibration direction of the vibrator 3 and the seventh magnet 3371 and the eighth magnet 3372 have opposite magnetization directions. Specifically, a side of the seventh magnet 3371 near the receiving cavity 315 is N pole, and a side thereof away from the receiving cavity 315 is S pole; and a side of the eighth magnet 3372 near the receiving cavity 315 is N pole, and a side thereof away from the receiving cavity 315 is S pole.

The elastic member 4 is fixed to the weight 31 at one end and is fixed to the housing 1 at the other end, for suspending the vibrator 3 in the receiving space. It is preferably to provide a reinforcement welding piece at the connections between the elastic member 4 and the weight 31 and/or between the elastic member 4 and the housing 1, which not only enhances the bonding force of the elastic member 4, but also prevents the elastic member 4 from being broken due to being bent excessively.

Compared with the related art, the magnetic circuit unit of the vibration motor according to the present disclosure includes a soft magnet and a coil sleeved on the soft magnet, and magnetically conductive plates and magnets are provided around the peripheral of the coil such that the Lorentz force generated by the magnets and the energized coil and the interaction force acting between the magnetized soft magnets and the magnet are superimposed and drive the weight to vibrate, thereby increasing the driving force for driving the weight and obtaining a quick response.

The above shows and describes the embodiments of the present disclosure. It is understandable that the embodiments above are only exemplary, and should not be interpreted as limiting the present disclosure, and those skilled in the art can make changes, modifications, replacements and deformations to the embodiments above within the scope of the present disclosure.

What is claimed is:

1. A vibration motor comprising:
a housing with a receiving space;
a vibrator received in the receiving space, the vibrator comprising a magnetic circuit unit for vibration; and
a stator received in the receiving space, the stator comprising a coil configured to drive the magnetic circuit unit to vibrate; the coil having a winding plane perpendicular to a vibration direction of the vibrator,
wherein the magnetic circuit unit comprises a first magnet group disposed at one side of the coil and a second magnet group disposed at the other side of the coil;
the first magnet group and the second magnet group are symmetrically arranged and each comprise a plurality of magnets arranged along the vibration direction of the vibrator and magnetized in a direction perpendicular to the vibration direction of the vibrator; and
magnetization directions of two adjacent magnets in the vibration direction of the vibrator are reverse to each other, and magnetization directions of the magnets oppositely arranged in the first magnet group and second magnet group are reverse to each other.

2. The vibration motor according to claim 1, wherein the magnetic circuit unit further comprises a magnetically conductive frame fixedly connected with the magnets, the magnetically conductive frame includes a first magnetically conductive plate attached to the first magnet group and a second magnetically conductive plate attached to the second magnet group, the first magnetically conductive plate is disposed on a side of the first magnet group away from the second magnet group, and the second magnetically conductive plate is disposed on a side of the second magnet group away from the first magnet group.

3. The vibration motor according to claim 2, wherein the vibrator further comprises a weight in which the magnetic circuit unit is mounted, the weight is suspended in the receiving space, the weight comprises two long side walls spaced apart and parallel to each other and two short side walls arranged at two ends of the long side walls and connecting the two long side walls, the long side walls and the short side walls are connected end to end to form a receiving cavity, and the magnetically conductive frame and the coil are received in the receiving cavity.

4. The vibration motor according to claim 3, wherein the first magnetically conductive plate is sandwiched between the first magnet group and one of the long side walls, and the second magnetically conductive plate is sandwiched between the second magnet group and the other of the long side walls.

5. The vibration motor according to claim 3, wherein the short side walls are recessed at opposite ends in a height direction of the housing to form notches, and the vibration motor further comprises limiting blocks corresponding to the notches, the limiting blocks are fixedly connected with the housing, and the notches cooperate with the limiting blocks to limit the displacement amount of the vibrator in the vibration direction.

6. The vibration motor according to claim 3, wherein the first magnet group comprises a first magnet, a second magnet and a third magnet arranged sequentially in the vibration direction, wherein the magnetization direction of the first magnet is opposite to that of the second magnet, and the magnetization direction of the first magnet is the same as that of the third magnet; the second magnet group comprises a fourth magnet, a fifth magnet and a sixth magnet arranged sequentially in the vibration direction, wherein the magnetization direction of the fourth magnet is opposite to that of the fifth magnet, and the magnetization direction of the four magnets is the same as that of the sixth magnet.

7. The vibration motor according to claim 6, wherein the first magnet and the fourth magnet are directly opposite to each other and have opposite magnetization directions; the second magnet and the fifth magnetic magnet are directly opposite to each other and have opposite magnetization directions; the third magnet and the sixth magnet are directly opposite to each other and have opposite magnetization directions.

8. The vibration motor according to claim 7, wherein the magnetic circuit unit further comprises a third magnet group fixed to the short side walls, the third magnet group comprises a seventh magnet and an eighth magnet arranged oppositely, the seventh magnet and the eighth magnet are magnetized in a direction parallel to the vibration direction of the vibrator such that the seventh magnet and the eighth magnet have opposite magnetization directions.

9. The vibration motor according to claim 3, wherein the vibration motor further comprises an elastic member which is fixed to the weight at one end and is fixed to the housing at the other end, thereby suspending the vibrator in the receiving space.

10. The vibration motor according to claim 3, wherein the vibration motor further comprises two elastic members, the weight comprises two ends in the vibration direction, one of the elastic members is fixed to one end of the weight and the housing, and the other one of the elastic members is fixed to the other end of the weight and the housing, thereby suspending the vibrator in the receiving space.

11. The vibration motor according to claim 1, wherein the stator further comprises a soft magnet fixedly connected to the coil and two brackets fixed at opposite ends of the soft magnet respectively, and the coil is fixedly connected to the housing and sleeved on the soft magnet.

12. The vibration motor according to claim 11, wherein at least one of the two brackets is provided separately from the soft magnet.
